(19) United States
(12) Patent Application Publication
(10) Pub. No.: US 2024/0291880 A1
(43) Pub. Date: Aug. 29, 2024

(54) Streaming Media Scheduling Method and Apparatus, and Readable Storage Medium

(71) Applicant: Huawei Cloud Computing Technologies Co., Ltd., Guizhou (CN)

(72) Inventors: Weihua Shan, Xi'an (CN); Dashuai Yan, Gui'an (CN)

(21) Appl. No.: 18/660,631

(22) Filed: May 10, 2024

Related U.S. Application Data
(63) Continuation of application No. PCT/CN2022/093466, filed on May 18, 2022.

(30) Foreign Application Priority Data
Nov. 11, 2021 (CN) 202111333353.X

(51) Int. Cl. H04L 65/61; H04L 65/80; H04N 21/234; H04N 21/239; H04N 21/262

(52) U.S. Cl. CPC H04L 65/61; H04L 65/80; H04N 21/23406; H04N 21/2393; H04N 21/26258

(57) ABSTRACT

A method includes that a streaming media server receives a play request that is for one channel of streaming media and that is sent by a client. The streaming media server selects N streaming media buffer nodes from M streaming media buffer nodes that buffer segments of the streaming media. The streaming media server sends a streaming media playlist to the client, where M is greater than N. When N is 1, the one selected streaming media buffer node buffers all segments of the streaming media. When N is greater than 1, the N selected streaming media buffer nodes each buffer a part of segments of the streaming media. The streaming media playlist includes addresses of the N streaming media buffer nodes, and indicates the client to obtain the segments of the streaming media based on the addresses of the N streaming media buffer nodes to play the streaming media.

### CROSS-REFERENCE TO RELATED APPLICATIONS

This is a continuation of International Patent Application No. PCT/CN2022/093466, filed on May 18, 2022, which claims priority to Chinese Patent Application No. 202111333353.X, filed on Nov. 11, 2021. The disclosures of the aforementioned applications are hereby incorporated by reference in their entireties.

### TECHNICAL FIELD

The present disclosure relates to the field of communication technologies, and in particular, to a streaming media scheduling method and apparatus, and a readable storage medium.

### BACKGROUND

Hyper Text Transfer Protocol (HTTP)Text Transfer Protocol (HTTP)-based adaptive bitrate streaming media transfer protocol is a streaming media network transfer protocol. Hyper HTTP Live Streaming (HLS) allows one piece of streaming media data to be divided into a plurality of segments of streaming media. For example, in a live streaming service, one channel of streaming media live streaming may be divided into a plurality of segments and a corresponding streaming media playlist may be generated by using HLS. When a streaming media client starts one streaming media session, the streaming media client first obtains a streaming media playlist file by using a content delivery network (CDN) server, then requests corresponding segments based on content in the playlist, and then completes locally playing streaming media based on the segments of the streaming media.

However, in a scenario (for example, a live streaming of a large release conference) with relatively high streaming media access concentration, a large quantity of streaming media clients simultaneously obtain segments of streaming media. Because a user scale that a CDN server can bear is limited, simultaneously obtaining the segments of the streaming media by the large quantity of streaming media clients causes phenomena such as frame freezing and frame loss to occur when the streaming media clients play streaming media content. This greatly affects user experience.

### SUMMARY

The present disclosure provides a streaming media scheduling method and apparatus, and a readable storage medium, to reduce a probability that frame freezing and frame loss occur when a streaming media client plays streaming media content. To achieve the foregoing objective, the following technical solutions are used in the present disclosure.

According to a first aspect, the present disclosure provides a streaming media scheduling method, and the method includes: A streaming media server first receives a play request that is for one channel of streaming media and that is sent by a client. The streaming media server selects N streaming media buffer nodes from M streaming media buffer nodes that buffer segments of the streaming media. Then the streaming media server sends a streaming media playlist to the client. M is greater than N. When N is 1, the one selected streaming media buffer node buffers all segments of the streaming media. When N is greater than 1, the N selected streaming media buffer nodes each buffer a part of segments of the streaming media. The streaming media playlist includes addresses of the N streaming media buffer nodes, and the streaming media playlist indicates the client to obtain the segments of the streaming media based on the addresses of the N streaming media buffer nodes to play the streaming media.

For example, one video open class whose duration is 60 minutes may be divided into 60 segments whose duration is 1 minute, and the 60 segments may be stored in the streaming media server and 100 streaming media buffer nodes. After receiving a play request that is for the video open class and that is sent by the client, the streaming media server may first select 10 streaming media buffer nodes from the 100 streaming media buffer nodes that buffer the segments of the video open class, and then send a streaming media playlist to the client to indicate the client to obtain the 60 segments of the video open class from addresses of the 10 streaming media buffer nodes to play the video open class.

In a scenario (for example, a live streaming of a large release conference) with relatively high streaming media access concentration, a large quantity of streaming media clients simultaneously obtain segments of streaming media. Because a user scale that a streaming media server (for example, a CDN server) can bear is limited, simultaneously obtaining the segments of the streaming media by the large quantity of streaming media clients causes phenomena such as frame freezing and frame loss to occur when the streaming media clients play streaming media content. In the method provided by the present disclosure, after receiving the play request that is for the one channel of streaming media and that is sent by the client, the streaming media server does not directly indicate the client to obtain the segments of the streaming media based on the address of the streaming media server, but first selects the N streaming media buffer nodes from the M streaming media buffer nodes that buffer the segments of the streaming media, and then sends the streaming media playlist to the client to indicate the client to obtain the segments of the streaming media based on the addresses of the N streaming media buffer nodes to play the streaming media. This prevents a large quantity of clients from simultaneously obtaining the segments of the streaming media from the streaming media server, so that frame freezing and frame loss can be avoided when the streaming media clients play streaming media content. In a process in which the streaming media server selects the streaming media buffer node, no additional signaling needs to be exchanged between the streaming media server and the client, so that the client is unaware of the event. This improves user experience.

In a possible implementation, the method may further include: The streaming media server determines K other clients that buffer other segments of the streaming media, where the streaming media playlist further includes addresses of the K other clients, and the streaming media playlist indicates the client to obtain all segments of the streaming media based on the addresses of the N streaming media buffer nodes and the addresses of the K other clients to play the streaming media.

For example, one video open class whose duration is 60 minutes may be divided into 60 segments whose duration is 1 minute, and the 60 segments may be stored in the streaming media server, 100 streaming media buffer nodes, and 300 clients. After receiving a play request that is for the video open class and that is sent by the client, the streaming media server may first select 10 streaming media buffer nodes from the 100 streaming media buffer nodes that buffer the segments of the video open class, select 20 other clients from the 300 other clients that buffer the segments of the video open class and that are other than the client that sends the request, and then send a streaming media playlist to the client to indicate the client to obtain the 60 segments of the video open class from addresses of the 10 streaming media buffer nodes and addresses of the 20 other clients to play the video open class.

It can be seen that, the streaming media server may not only indicate the client to obtain the segments of the streaming media based on the address of the streaming media buffer node to play the streaming media, but also indicate the client to obtain the segments of the streaming media based on the addresses of the other clients to play the streaming media. This further prevents a large quantity of clients from simultaneously obtaining the segments of the streaming media from the streaming media server, so that frame freezing and frame loss can be avoided when the streaming media clients play streaming media content.

In a possible implementation, the N streaming media buffer nodes buffer all segments of the streaming media, and the streaming media playlist indicates the client to obtain all segments of the streaming media based on the addresses of the N streaming media buffer nodes to play the streaming media.

Optionally, M, N, and K are all positive integers.

For example, M may be 100, N may be 10, and K may be 300.

In a possible implementation, the selecting N streaming media buffer nodes from M streaming media buffer nodes that buffer segments of the streaming media includes: selecting, based on status information of the M streaming media buffer nodes, N streaming media buffer nodes from the M streaming media buffer nodes that buffer the segments of the streaming media, where the status information includes at least one of load information, memory utilization, an available memory, storage space utilization, an available storage space, a network type, or streaming media segment storage information. The network type indicates a network type (for example, a dedicated network) of the streaming media buffer node, and the streaming media segment storage information indicates a specific segment of the streaming media stored in the streaming media buffer node.

It can be seen that, when selecting the streaming media buffer node, the streaming media server may select a streaming media buffer node in a relatively good state based on status information of the streaming media buffer node, so that the client obtains a segment of the streaming media based on an address of the streaming media buffer node in the relatively good state to play the streaming media. This prevents the client from obtaining a segment of the streaming media based on an address of a streaming media buffer node in a relatively poor state to play the streaming media, so that frame freezing and frame loss can be avoided when the clients play streaming media content.

In another possible implementation, the selecting N streaming media buffer nodes from M streaming media buffer nodes that buffer segments of the streaming media includes: selecting N streaming media buffer nodes with lowest load rates from the M streaming media buffer nodes that buffer the segments of the streaming media, where when N is 1, a load rate of the one selected streaming media buffer node is the lowest in the M streaming media buffer nodes, or when N is greater than 1, a load rate of each streaming media buffer node in the N selected streaming media buffer nodes is the lowest in the streaming media buffer nodes that each buffer a part of segments of the streaming media.

For example, one video open class whose duration is 60 minutes may be divided into 60 segments whose duration is 1 minute, and the 60 segments may be stored in the streaming media server and 100 streaming media buffer nodes. A streaming media buffer node A is a node with a lowest load rate in the 100 streaming media buffer nodes. After receiving a play request that is for the video open class and that is sent by the client, the streaming media server may first select the node with the lowest load rate, namely, the streaming media buffer node A, from the 100 streaming media buffer nodes that buffer the segments of the video open class, and then send a streaming media playlist to the client to indicate the client to obtain the 60 segments of the video open class based on an address of the media buffer node A to play the video open class.

It may be understood that, the client is indicated to obtain the segments of the streaming media based on the addresses of the N streaming media buffer nodes with the lowest load rate to play the streaming media, to prevent the client from obtaining the segment of the streaming media by using a streaming media buffer node with a relatively high load rate, so that phenomena such as frame freezing and frame loss can be avoided when the streaming media clients play the streaming media content. This further improves user experience.

In still another possible implementation, the selecting N streaming media buffer nodes from M streaming media buffer nodes that buffer segments of the streaming media includes: selecting, based on status information of the M streaming media buffer nodes and attribute information of the M streaming media buffer nodes, N streaming media buffer nodes from the M streaming media buffer nodes that buffer the segments of the streaming media.

Optionally, the foregoing attribute information includes at least one of an inter-node address, attribute parameter information, or streaming media segment content information. The inter-node address may include an Internet Protocol version 4 (IPv4) address and a port number, and an Internet Protocol version 6 (IPv6) address and a port number. The attribute parameter information may include a network address translation (NAT) type, an operator, a network type, and available space of a memory and a disk. The streaming media segment content information may include update time of the segment of the streaming media and load of the node.

For example, one video open class whose duration is 60 minutes may be divided into 60 segments whose duration is 1 minute, and the 60 segments may be stored in the streaming media server and 100 streaming media buffer nodes. After receiving a play request that is for the video open class and that is sent by the client, the streaming media server may first select 30 streaming media buffer nodes whose network types are dedicated networks from the 100 streaming media buffer nodes that buffer the segments of the video open class, then select 10 streaming media buffer nodes whose load rates are the lowest from the 30 streaming media buffer nodes whose network types are the dedicated networks, and then send a streaming media playlist to the client to indicate the client to obtain the 60 segments of the video open class from addresses of the 10 streaming media buffer nodes to play the video open class.

For another example, one video open class whose duration is 60 minutes may be divided into 60 segments whose duration is 1 minute, and the 60 segments may be stored in the streaming media server and 100 streaming media buffer nodes. After receiving a play request that is for the video open class and that is sent by the client, the streaming media server may first select 70 streaming media buffer nodes that support IPv6 from the 100 streaming media buffer nodes that buffer the segments of the video open class, then select 20 streaming media buffer nodes with lowest load rates from the 70 streaming media buffer nodes that supports IPV6, and then send a streaming media playlist to the client to indicate the client to obtain the 60 segments of the video open class from addresses of the 20 streaming media buffer nodes to play the video open class.

Optionally, N may be equal to a quantity of segments of the streaming media.

For example, if a video open class includes 60 segments, the streaming media server needs to select 60 streaming media buffer nodes from M streaming media buffer nodes that buffer the segments of the video open class.

It may be understood that, when N is equal to the quantity of segments of the streaming media, the client downloads in parallel different segments by using different streaming media buffer nodes, so that time required by the client to download the segments is shortened. This further improves user experience. For example, a live video includes three segments with sizes of 1 megabyte (MB). If the client simultaneously downloads the three segments from a same streaming media buffer node whose bandwidth is 10 megabytes per second (Mbps), required download time is 2.4 seconds. However, if the client downloads one segment from each of three different streaming media buffer nodes whose bandwidths are all 10 Mbps, required download time is only 0.8 seconds. It can be seen that the time required for downloading the segments is significantly reduced.

Optionally, the streaming media buffer node may store the segments of the streaming media in a distributed storage manner. For example, each streaming media buffer node or each streaming media buffer node set may store only one segment of same streaming media content. The streaming media buffer nodes include a streaming media buffer node A, a streaming media buffer node B, and a streaming media buffer node C, and streaming media content 1 includes a segment 1, a segment 2, and a segment 3. A size of each segment is 1 MB. If each streaming media buffer node stores all segments of the streaming media content 1, a size of required storage space is 3 MB. However, if each streaming media buffer node stores only one segment of the streaming media content 1, a size of required storage space is only 1 MB. For example, the streaming media buffer node A stores the segment 1 of the streaming media, the streaming media buffer node B stores the segment 2 of the streaming media, and the streaming media buffer node C stores the segment 3 of the streaming media.

According to a second aspect, the present disclosure further provides another streaming media scheduling method, and the method includes: A client first receives target information sent by a streaming media server, where the target information includes attribute information of M streaming media buffer nodes, and then the client downloads a plurality of segments of streaming media based on the attribute information of the M streaming media buffer nodes.

In other technologies, the client can download the segments of the streaming media based only on an address of a streaming media buffer node indicated by a streaming media playlist. However, in the streaming media scheduling method provided by the present disclosure, the client may independently select attribute information of the streaming media buffer node based on obtained attribute information of the streaming media buffer node to download the segments of the streaming media. This prevents the client from downloading the segment of the streaming media by using a streaming media buffer node when the streaming media buffer node is in a relatively poor state, so that frame freezing and frame loss can be avoided when the clients play streaming media content.

Optionally, the foregoing attribute information includes at least one of an inter-node address, attribute parameter information, or streaming media segment content information. The inter-node address may include an IPV4 address and a port number, and an IPV6 address and a port number. The attribute parameter information may include a NAT type, an operator, a network type, and available space of a memory and a disk. The streaming media segment content information may include update time of the segment of the streaming media and load of the node.

In a possible implementation, the target information further includes a streaming media playlist, and the downloading a plurality of segments of streaming media based on the attribute information of the M streaming media buffer nodes includes: downloading the plurality of segments based on the streaming media playlist and the attribute information of the M streaming media buffer nodes. The streaming media playlist includes addresses of N streaming media buffer nodes, and the streaming media playlist indicates the client to obtain the segments of the streaming media based on the addresses of the N streaming media buffer nodes to play the streaming media.

In a possible implementation, the downloading the plurality of segments based on the streaming media playlist and the attribute information of the M streaming media buffer nodes includes: obtaining latencies between the client and the N streaming media buffer nodes based on the streaming media playlist; and downloading the plurality of segments based on the attribute information of the M streaming media buffer nodes when a latency between the client and any streaming media buffer node in the N streaming media buffer nodes is greater than a latency threshold.

In a possible implementation, the target information further includes attribute information of K other clients, and the downloading a plurality of segments of streaming media based on the attribute information of the M streaming media buffer nodes includes: downloading the plurality of segments based on the attribute information of the M streaming media buffer nodes and the attribute information of the K other clients.

Optionally, M, N, and K are all positive integers.

For example, M may be 100, N may be 10, and K may be 300.

According to a third aspect, the present disclosure further provides a streaming media scheduling apparatus, where the apparatus includes a processing unit, and the processing unit is configured to: receive a play request that is for one channel of streaming media and that is sent by a client; select N streaming media buffer nodes from M streaming media buffer nodes that buffer segments of the streaming media, where M is greater than N, and when N is 1, the one selected streaming media buffer node buffers all segments of the streaming media, or when N is greater than 1, the N selected streaming media buffer nodes each buffer a part of segments of the streaming media; and send a streaming media playlist to the client, where the streaming media playlist includes addresses of the N streaming media buffer nodes, and the streaming media playlist indicates the client to obtain the segments of the streaming media based on the addresses of the N streaming media buffer nodes to play the streaming media.

In a possible implementation, the processing unit is further configured to determine K other clients that buffer other segments of the streaming media, where the streaming media playlist further includes addresses of the K other clients, and the streaming media playlist indicates the client to obtain all segments of the streaming media based on the addresses of the N streaming media buffer nodes and the addresses of the K other clients to play the streaming media.

In a possible implementation, the N streaming media buffer nodes buffer all segments of the streaming media, and the streaming media playlist indicates the client to obtain all segments of the streaming media based on the addresses of the N streaming media buffer nodes to play the streaming media.

Optionally, M, N, and K are all positive integers.

For example, M may be 100, N may be 10, and K may be 300.

In a possible implementation, the processing unit is specifically configured to select, based on status information of the M streaming media buffer nodes, N streaming media buffer nodes from the M streaming media buffer nodes that buffer the segments of the streaming media, where the status information includes at least one of load information, memory utilization, an available memory, storage space utilization, an available storage space, a network type, or streaming media segment storage information.

In another possible implementation, the processing unit is specifically configured to select N streaming media buffer nodes with lowest load rates from the M streaming media buffer nodes that buffer the segments of the streaming media, where when N is 1, a load rate of the one selected streaming media buffer node is the lowest in the M streaming media buffer nodes, or when N is greater than 1, a load rate of each streaming media buffer node in the N selected streaming media buffer nodes is the lowest in the streaming media buffer nodes that each buffer a part of segments of the streaming media.

In still another possible implementation, the processing unit is specifically configured to select, based on status information of the M streaming media buffer nodes and attribute information of the M streaming media buffer nodes, N streaming media buffer nodes from the M streaming media buffer nodes that buffer the segments of the streaming media, where the status information includes at least one of load information, memory utilization, an available memory, storage space utilization, an available storage space, a network type, or streaming media segment storage information, and the attribute information includes at least one of an inter-node address, attribute parameter information, or streaming media segment content information.

According to a fourth aspect, the present disclosure further provides another streaming media scheduling apparatus. The apparatus includes a processing unit and the processing unit is configured to: receive target information sent by a streaming media server, where the target information includes attribute information of M streaming media buffer nodes, and download a plurality of segments of streaming media based on the attribute information of the M streaming media buffer nodes, where the attribute information includes at least one of an inter-node address, attribute parameter information, or streaming media segment content information.

In a possible implementation, the target information further includes a streaming media playlist, and the processing unit is specifically configured to download the plurality of segments based on the streaming media playlist and the attribute information of the M streaming media buffer nodes. The streaming media playlist includes addresses of N streaming media buffer nodes, and the streaming media playlist indicates the client to obtain the segments of the streaming media based on the addresses of the N streaming media buffer nodes to play the streaming media.

In a possible implementation, the processing unit is specifically configured to: obtain latencies between the client and the N streaming media buffer nodes based on the streaming media playlist, and download the plurality of segments based on the attribute information of the M streaming media buffer nodes when a latency between the client and any streaming media buffer node in the N streaming media buffer nodes is greater than a latency threshold.

In a possible implementation, the target information further includes attribute information of K other clients, and the processing unit is specifically configured to download the plurality of segments based on the attribute information of the M streaming media buffer nodes and the attribute information of the K other clients.

Optionally, M, N, and K are all positive integers.

For example, M may be 100, N may be 10, and K may be 300.

According to a fifth aspect, the present disclosure further provides a streaming media scheduling apparatus. The apparatus includes at least one processor, and when the at least one processor executes program code or instructions, the method according to any one of the first aspect or the possible implementations of the first aspect.

Optionally, the electronic device may further include at least one memory, and the at least one memory is configured to store the program code or the instructions.

According to a sixth aspect, the present disclosure further provides a chip that includes an input interface, an output interface, and at least one processor. Optionally, the chip further includes a memory. The at least one processor is configured to execute code in the memory. When the at least one processor executes the code, the chip implements the method according to any one of the first aspect or the possible implementations of the first aspect.

Optionally, the chip may further be an integrated circuit.

According to a seventh aspect, the present disclosure further provides a computer-readable storage medium configured to store a computer program. The computer program includes instructions for implementing the method according to any one of the first aspect or the possible implementations of the first aspect.

According to an eighth aspect, the present disclosure further provides a computer program product that includes instructions. When the computer program product is run on a computer, the computer is enabled to implement the method according to any one of the first aspect or the possible implementations of the first aspect.

The streaming media scheduling apparatus, the computer storage medium, the computer program product, and the chip provided in embodiments are all configured to perform the streaming media scheduling method provided above. Therefore, for beneficial effects that can be achieved by the streaming media scheduling apparatus, the computer storage medium, the computer program product, and the chip, refer to the beneficial effects in the streaming media scheduling method provided above. Details are not described herein again.

### BRIEF DESCRIPTION OF DRAWINGS

To describe the technical solutions in embodiments of the present disclosure more clearly, the following briefly describes the accompanying drawings used in describing embodiments. It is clear that the accompanying drawings in the following descriptions are merely some embodiments of the present disclosure, and a person of ordinary skill in the art may still derive other drawings from these accompanying drawings without creative efforts.

FIG. 1 is a schematic diagram of a structure of a communication system according to an embodiment of the present disclosure;

FIG. 2 is a schematic flowchart of a streaming media scheduling method according to an embodiment of the present disclosure;

FIG. 3 is a schematic diagram of a topology relationship between devices according to an embodiment of the present disclosure;

FIG. 4 is a schematic flowchart of another streaming media scheduling method according to an embodiment of the present disclosure;

FIG. 5 is a schematic diagram of a structure of an apparatus according to an embodiment of the present disclosure;

FIG. 6 is a schematic diagram of a structure of another apparatus according to an embodiment of the present disclosure; and

FIG. 7 is a schematic diagram of a structure of a chip according to an embodiment of the present disclosure.

### DESCRIPTION OF EMBODIMENTS

The following clearly describes the technical solutions in embodiments of the present disclosure with reference to the accompanying drawings in embodiments of the present disclosure. It is clear that the described embodiments are merely a part rather than all of embodiments of the present disclosure. All other embodiments obtained by a person of ordinary skill in the art based on embodiments of the present disclosure without creative efforts shall fall within the protection scope of the present disclosure.

The term “and/or” in this specification describes only an association relationship between associated objects and indicates that three relationships may exist. For example, A and/or B may indicate the following three cases: Only A exists, both A and B exist, and only B exists.

In this specification and accompanying drawings of the present disclosure, the terms “first”, “second”, and the like are intended to distinguish between different objects or distinguish between different processing of a same object, but do not indicate a particular order of the objects.

In addition, the terms “including”, “having”, or any other variant thereof in descriptions of the present disclosure are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

It should be noted that, in descriptions of embodiments of the present disclosure, terms such as “example” or “for example” are used to represent giving an example, an illustration, or a description. Any embodiment or design scheme described as “example” or “for example” in embodiments of the present disclosure should not be explained as being more preferred or having more advantages than another embodiment or design scheme. Exactly, use of the word “example”, “for example”, or the like is intended to present a relative concept in a specific manner.

In descriptions of the present disclosure, unless otherwise specified, “a plurality of” means two or more than two.

In a scenario (for example, a live streaming of a large release conference) with relatively high streaming media access concentration, a large quantity of streaming media clients simultaneously obtain segments of streaming media. Because a user scale that a CDN server can bear is limited, simultaneously obtaining the segments of the streaming media by the large quantity of streaming media clients causes phenomena such as frame freezing and frame loss to occur when the streaming media clients play streaming media content. This greatly affects user experience. Therefore, an embodiment of the present disclosure provides a streaming media scheduling method, to reduce a probability that frame freezing and frame loss occur when the streaming media client plays the streaming media content. The streaming media scheduling method may be applied to a communication system.

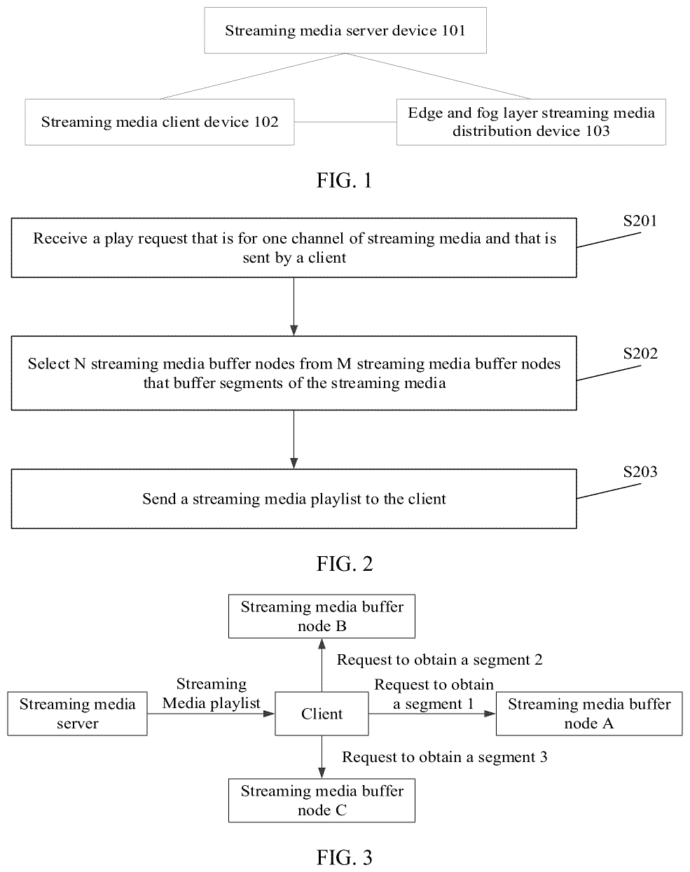

For example, FIG. 1 is a schematic diagram of a structure of a communication system 100 according to an embodiment of the present disclosure. A communication system may include a streaming media server device 101, a streaming media client device 102, and an edge and fog layer streaming media distribution device 103.

It may be understood that the structure shown in this embodiment of the present disclosure does not constitute a specific limitation on the communication system 100. In some other embodiments of the present disclosure, the communication system 100 may include more or fewer components than those shown in the figure, or some components may be combined, or some components may be split, or different component arrangements may be used. The components shown in the figure may be implemented by hardware, software, or a combination of software and hardware.

The streaming media server device 101 may be a server, a server cluster, or another device that has a computing function and a communication function. This embodiment of the present disclosure does not limit a specific type of the streaming media server device 101. The streaming media server device 101 may also be referred to as a streaming media server for short.

The streaming media client device 102 may be an electronic device such as a mobile phone, a tablet computer, a wearable device, a vehicle-mounted device, an augmented reality (AR)/virtual reality (VR) device, a notebook computer, an ultra-mobile personal computer (UMPC), a netbook, or a personal digital assistant (PDA). This embodiment of the present disclosure does not limit a specific type of the streaming media client device 102. The streaming media client device 102 may also be referred to as a client for short.

The edge and fog layer streaming media distribution device 103 may be an optical modem, a router, a home gateway, an optical line terminal (OLT), or another device having a computing function and a communication function. A specific type of the edge and fog layer streaming media distribution device 103 is not limited in this embodiment of the present disclosure, and the edge and fog layer streaming media distribution device 103 may be referred to as a streaming media buffer node for short.

The streaming media server device 101, the streaming media client device 102, and the edge and fog layer streaming media distribution device 103 may communicate with each other by using a communication technology.

In a possible implementation, the streaming media server device 101, the streaming media client device 102, and the edge and fog layer streaming media distribution device 103 may communicate with each other in a wireless manner.

It should be noted that, communication in the wireless manner may be implemented by using a communication network. The communication network may be a local area network, or may be a wide area network switched by using a relay device, or may include a local area network and a wide area network. When the communication network is the local area network, for example, the communication network may be a Wi-Fi hotspot network, a Wi-Fi P2P network, a Bluetooth network, a ZigBee network, a near-field communication (NFC) network, a future possible universal short range communication network, or a dedicated short-range communication (DSRC) network. When the communication network is a wide area network, an example of example, the communication network may be a 3rd-generation mobile communication technology (3G) network, a 4th-generation mobile communication technology (4G) network, a 5th-generation mobile communication technology (5G) network, a PLMN, or the Internet. This is not limited in this embodiment of the present disclosure.

For example, the communication system 100 may be a multicast network, an application layer multicast network, or a streaming media application layer multicast network.

The following describes in detail the streaming media scheduling method provided in an embodiment of the present disclosure with reference to the accompanying drawings. As shown in FIG. 2, the streaming media scheduling method provided in this embodiment of the present disclosure includes the following steps.

S201: A streaming media server receives a play request that is for one channel of streaming media and that is sent by a client.

For example, if a user wants to watch a video open class by using a mobile phone, the user taps an icon of a streaming media software development kit (SDK) client on the mobile phone, starts the streaming media SDK client to display an interface of the streaming media SDK client, and then taps a video open class page in the interface. A CDN server receives, in response to the operation of the user, a play request that is for the video open class and that is sent by the mobile phone by using the streaming media SDK client.

S202: The streaming media server selects N streaming media buffer nodes from M streaming media buffer nodes that buffer segments of the streaming media.

M is greater than N. When N is 1, the one selected streaming media buffer node buffers all segments of the streaming media. When N is greater than 1, the N selected streaming media buffer nodes each buffer a part of segments of the streaming media.

For example, one video open class whose duration is 60 minutes may be divided into 60 segments whose duration is 1 minute, and the 60 segments may be stored in the streaming media server and 100 streaming media buffer nodes. After receiving a play request that is for the video open class and that is sent by the client, the streaming media server may select one streaming media buffer node that stores the 60 segments from the 100 streaming media buffer nodes that buffer the segments of the video open class, and then generate a streaming media playlist that includes an address of the one streaming media buffer node.

For another example, one video open class whose duration is 60 minutes may be divided into 60 segments whose duration is 1 minute, and the 60 segments may be stored in the streaming media server and 100 streaming media buffer nodes. After receiving a play request that is for the video open class and that is sent by the client, the streaming media server may select 10 streaming media buffer nodes from the 100 streaming media buffer nodes that buffer the segments of the video open class, and then generate a streaming media playlist that includes addresses of the 10 streaming media buffer nodes.

In a possible implementation, the streaming media server may further determine K other clients that buffer other segments of the streaming media.

For another example, one video open class whose duration is 60 minutes may be divided into 60 segments whose duration is 1 minute, and the 60 segments may be stored in the streaming media server, 100 streaming media buffer nodes, and 300 clients. After receiving a play request that is for the video open class and that is sent by the client, the streaming media server may first select 10 streaming media buffer nodes from the 100 streaming media buffer nodes that buffer the segments of the video open class, select 20 other clients from the 300 other clients that buffer the segments of the video open class and that are other than the client that sends the request, and then generate a streaming media playlist that includes addresses of the 10 streaming media buffer nodes and addresses of the 20 other clients.

It can be seen that, the streaming media server may not only indicate the client to obtain the segments of the streaming media based on the address of the streaming media buffer node to play the streaming media, but also indicate the client to obtain the segments of the streaming media based on the addresses of the other clients to play the streaming media. This further prevents a large quantity of clients from simultaneously obtaining the segments of the streaming media from the streaming media server, so that frame freezing and frame loss can be avoided when the streaming media clients play streaming media content.

Optionally, M, N, and K are all positive integers. For example, M may be 100, N may be 10, and K may be 300.

In a possible implementation, the streaming media server may select, based on status information of the M streaming media buffer nodes, N streaming media buffer nodes from the M streaming media buffer nodes that buffer the segments of the streaming media, where the status information includes at least one of load information, memory utilization, an available memory, storage space utilization, an available storage space, a network type, or streaming media segment storage information. The network type indicates a network type (for example, a dedicated network) of the streaming media buffer node, and the streaming media segment storage information indicates a specific segment of the streaming media stored in the streaming media buffer node.

It can be seen that, when selecting the streaming media buffer node, the streaming media server may select a streaming media buffer node in a relatively good state based on status information of the streaming media buffer node, so that the client obtains a segment of the streaming media based on an address of the streaming media buffer node in the relatively good state to play the streaming media. This prevents the client from obtaining a segment of the streaming media based on an address of a streaming media buffer node in a relatively poor state to play the streaming media, so that frame freezing and frame loss can be avoided when the clients play streaming media content.

In a possible implementation, the streaming media server may select N streaming media buffer nodes with lowest load rates from the M streaming media buffer nodes that buffer the segments of the streaming media.

When N is 1, a load rate of the one selected streaming media buffer node is the lowest in the M streaming media buffer nodes. When N is greater than 1, a load rate of each streaming media buffer node in the N selected streaming media buffer nodes is the lowest in the streaming media buffer nodes that each buffer a part of segments of the streaming media.

For example, one video open class whose duration is 60 minutes may be divided into 60 segments whose duration is 1 minute. A streaming media buffer node A, a streaming media buffer node B, a streaming media buffer node C, and a streaming media buffer node D each store the 60 segments. After receiving a play request that is for the video open class and that is sent by the client, the streaming media server may select one streaming media buffer node (that is, the streaming media buffer node C) with a lowest load rate from the foregoing streaming media buffer nodes based on streaming media buffer node information shown in Table 1, and then generate a streaming media playlist that includes an address (that is, d.com:80) of the media buffer node C.

TABLE 1

| | Load information | |
|---|---|---|
| Streaming media buffer nodes | (load rates) | Addresses |
| Streaming media buffer node A | 35% | a.com: 80 |
| Streaming media buffer node B | 65% | b.com: 80 |
| Streaming media buffer node C | 25% | c.com: 80 |
| Streaming media buffer node D | 50% | d.com: 80 |

For another example, one video release conference whose duration is 15 minutes may be divided into three segments whose duration is 5 minutes. As shown in Table 2, a streaming media buffer node A buffers a segment 1, a streaming media buffer node B buffers a segment 2, and a streaming media buffer node C and a streaming media buffer node D buffer a segment 3. After receiving a play request that is for the video release conference and that is sent by the client, the streaming media server may separately select, from the streaming media buffer nodes based on streaming media buffer node information shown in Table 2, a streaming media buffer node with a lowest load rate in the streaming media buffer node that buffers the segment 1, a streaming media buffer node with a lowest load rate in the streaming media buffer node that buffers the segment 2, and a streaming media buffer node with a lowest load rate in the streaming media buffer nodes that buffer the segment 3 (that is, the streaming media buffer node A, the streaming media buffer node B, and the streaming media buffer node C), and then generate a streaming media playlist that includes addresses (that is, a.com:80, b.com:80, and c.com:80) of the streaming media buffer node A, the streaming media buffer node B, and the streaming media buffer node C.

TABLE 2

| Streaming media | Load information | Buffered | |
|---|---|---|---|
| buffer nodes | (load rates) | segments | Addresses |
| Streaming media | 35% | Segment 1 | a.com: 80 |
| buffer node A | | | |
| Streaming media | 65% | Segment 2 | b.com: 80 |
| buffer node B | | | |
| Streaming media | 25% | Segment 3 | c.com: 80 |
| buffer node C | | | |
| Streaming media | 50% | Segment 3 | d.com: 80 |
| buffer node D | | | |

It may be understood that, the client is indicated to obtain the segments of the streaming media based on the addresses of the N streaming media buffer nodes with the lowest load rate to play the streaming media, to prevent the client from obtaining the segment of the streaming media by using a streaming media buffer node with a relatively high load rate, so that phenomena such as frame freezing and frame loss can be avoided when the streaming media clients play the streaming media content. This further improves user experience.

In a possible implementation, the streaming media server may select, based on status information of the M streaming media buffer nodes and attribute information of the M streaming media buffer nodes, N streaming media buffer nodes from the M streaming media buffer nodes that buffer the segments of the streaming media.

Optionally, the foregoing attribute information includes at least one of an inter-node address, attribute parameter information, or streaming media segment content information. The inter-node address may include an IPV4 address and a port number, and an IPV6 address and a port number. The attribute parameter information may include a NAT type, an operator, a network type, and available space of a memory and a disk. The streaming media segment content information may include update time of the segment of the streaming media and load of the node.

For example, one video open class whose duration is 60 minutes may be divided into 60 segments whose duration is 1 minute, and the 60 segments may be stored in the streaming media server and 100 streaming media buffer nodes. After receiving a play request that is for the video open class and that is sent by the client, the streaming media server may first select 30 streaming media buffer nodes whose network types are the dedicated networks from the 100 streaming media buffer nodes that buffer the segments of the video open class, then select 10 streaming media buffer nodes whose load rates are the lowest from the 30 streaming media buffer nodes whose network types are the dedicated networks, and then generate a streaming media playlist that includes addresses of the 10 streaming media buffer nodes.

For another example, one video open class whose duration is 60 minutes may be divided into 60 segments whose duration is 1 minute, and the 60 segments may be stored in the streaming media server and 100 streaming media buffer nodes. After receiving a play request that is for the video open class and that is sent by the client, the streaming media server may first select 70 streaming media buffer nodes that support IPv6 from the 100 streaming media buffer nodes that buffer the segments of the video open class, then select 20 streaming media buffer nodes with lowest load rates from the 70 streaming media buffer nodes that support IPV6, and then generate a streaming media playlist that includes addresses of the 20 streaming media buffer nodes.

Optionally, N may be equal to a quantity of segments of the streaming media. For example, if a video open class includes 60 segments, the streaming media server needs to select 60 streaming media buffer nodes from M streaming media buffer nodes that buffer the segments of the video open class.

It may be understood that, when N is equal to the quantity of segments of the streaming media, the client downloads in parallel different segments by using different streaming media buffer nodes, so that time required by the client to download the segments is shortened. This further improves user experience. For example, a live video includes three segments with sizes of 1 MB. If the client simultaneously downloads the three segments from a same streaming media buffer node whose bandwidth is 10 Mbps, required download time is 2.4 seconds. However, if the client downloads one segment from each of three different streaming media buffer nodes whose bandwidths are all 10 Mbps, required download time is only 0.8 seconds. It can be seen that the time required for downloading the segments is significantly reduced.

Optionally, the streaming media buffer node may store the segments of the streaming media in a distributed storage manner. For example, each streaming media buffer node or each streaming media buffer node set may store only one segment of same streaming media content. The streaming media buffer nodes include a streaming media buffer node A, a streaming media buffer node B, and a streaming media buffer node C, and streaming media content 1 includes a segment 1, a segment 2, and a segment 3. A size of each segment is 1 MB. If each streaming media buffer node stores all segments of the streaming media content 1, a size of required storage space is 3 MB. However, if each streaming media buffer node stores only one segment of the streaming media content 1, a size of required storage space is only 1 MB. For example, the streaming media buffer node A stores the segment 1 of the streaming media, the streaming media buffer node B stores the segment 2 of the streaming media, and the streaming media buffer node C stores the segment 3 of the streaming media.

Optionally, before S202, the client and the streaming media buffer node may send a node registration request to the streaming media server to complete registration. Selecting N streaming media buffer nodes from the M streaming media buffer nodes that buffer the segments of the streaming media may include: selecting N streaming media buffer nodes from L streaming media buffer nodes that are registered and buffer the segments of the streaming media.

It may be understood that, a plurality of streaming media client devices may exist in a streaming media network (a multicast network, an application layer multicast network, or a streaming media application layer multicast network). After the streaming media client devices are registered in the streaming media server device, the streaming media client devices may alternatively transmit the segments of the streaming media to each other. This reduces load of the streaming media server devices and an edge and fog layer streaming media distribution device, and further improves user experience.

S203: The streaming media server sends a streaming media playlist to the client.

The streaming media playlist includes addresses of the N streaming media buffer nodes, and the streaming media playlist indicates the client to obtain the segments of the streaming media based on the addresses of the N streaming media buffer nodes to play the streaming media.

It can be seen that, in the method provided by the present disclosure, after receiving the play request that is for the one channel of streaming media and that is sent by the client, the streaming media server does not directly indicate the client to obtain the segments of the streaming media based on the address of the streaming media server, but first selects the N streaming media buffer nodes from the M streaming media buffer nodes that buffer the segments of the streaming media, and then sends the streaming media playlist to the client to indicate the client to obtain the segments of the streaming media based on the addresses of the N streaming media buffer nodes to play the streaming media. This prevents a large quantity of clients from simultaneously obtaining the segments of the streaming media from the streaming media server, so that frame freezing and frame loss can be avoided when the streaming media clients play streaming media content. In a process in which the streaming media server selects the streaming media buffer node, no additional signaling needs to be exchanged between the streaming media server and the client, so that the client is unaware of the event. This improves user experience.

In a possible implementation, the streaming media playlist may further include addresses of the K other clients, and the streaming media playlist indicates the client to obtain all segments of the streaming media based on the addresses of the N streaming media buffer nodes and the addresses of the K other clients to play the streaming media.

When the N streaming media buffer nodes buffer all segments of the streaming media, the streaming media playlist indicates the client to obtain all segments of the streaming media based on the addresses of the N streaming media buffer nodes to play the streaming media.

Optionally, the streaming media playlist may further include the quantity of segments, maximum duration and actual duration of the segment, and a file name and address of the segment. The streaming media playlist may use a plurality of types of file formats. For example, the streaming media playlist may be an extended moving picture experts group audio layer 3 uniform resource locator (M3U) file that includes metadata, or an M3U file in a unicode transformation format (UTF)-8 encoding format, namely, an m3u8 file.

For example, one video open class whose duration is 30 minutes may be divided into three segments (that is, a segment 1, a segment 2, and a segment 3) whose duration is 10 minutes. As shown in FIG. 3, a streaming media server sends a video open class playlist to a client, where the video playlist indicates the client to obtain the segment 1 based on an address http://a.com:80 of a streaming media buffer node A, obtain the segment 2 based on an address http://b.com:80 of a streaming media buffer node B, and obtain the segment 3 based on an address http://c.com:80 of a streaming media buffer node C.

In a possible implementation, the streaming media server may alternatively send the attribute information of the M streaming media buffer nodes to the client. After receiving the attribute information of the M streaming media buffer nodes, the client may download the plurality of segments of the streaming media based on the attribute information of the M streaming media buffer nodes.

For example, the streaming media server may send attribute information of 100 streaming media buffer nodes to the client. After receiving the attribute information of the 100 streaming media buffer nodes, the client may first determine an address of each streaming media buffer node based on the attribute information, then test a network latency between the client and each streaming media buffer node based on the address of the streaming media buffer node, and then download a plurality of segments of the streaming media based on an address of a streaming media buffer node with a lowest network latency with the client.

In another possible implementation, the streaming media server may alternatively send the attribute information of the M streaming media buffer nodes and attribute information of the K other clients to the client. After receiving the attribute information of the M streaming media buffer nodes and the attribute information of the K other clients, the client may download the plurality of segments of the streaming media based on the attribute information of the M streaming media buffer nodes and the attribute information of the K other clients.

In still another possible implementation, the streaming media server may alternatively send the streaming media playlist and the attribute information of the M streaming media buffer nodes to the client. After receiving the streaming media playlist and the attribute information of the M streaming media buffer nodes, the client may download the plurality of segments of the streaming media based on the streaming media playlist and the attribute information of the M streaming media buffer nodes.

For example, the streaming media server sends target information to the client, where the target information includes the streaming media playlist and the attribute information of the M streaming media buffer nodes. After receiving the target information, the client may obtain latencies between the client and the N streaming media buffer nodes based on the streaming media playlist, and then download the plurality of segments based on the attribute information of the M streaming media buffer nodes when a latency between the client and any streaming media buffer node in the N streaming media buffer nodes is greater than a latency threshold.

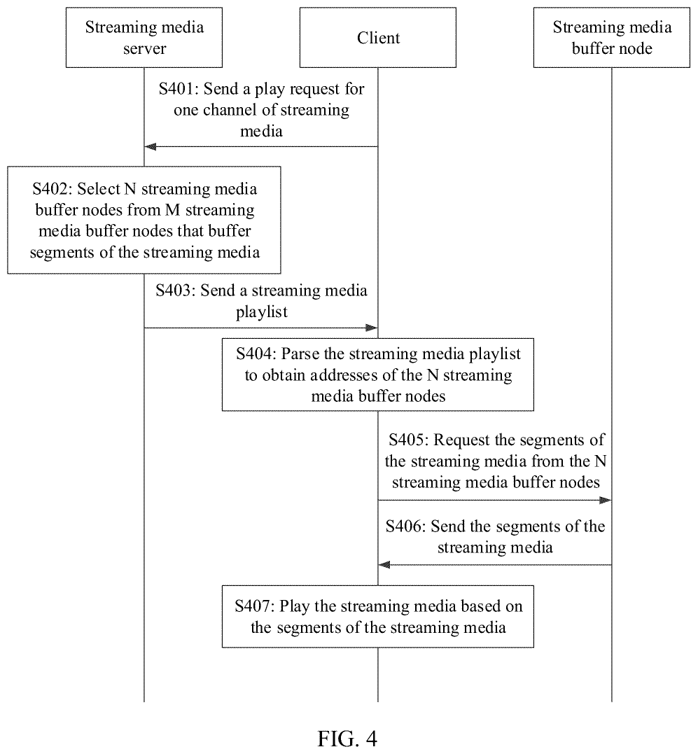

The following describes in detail communication interaction between a streaming media server, a client, and a streaming media buffer node in the streaming media scheduling method provided by this embodiment of the present disclosure with reference to FIG. 4. The communication interaction between the streaming media server, the client, and the streaming media buffer node specifically includes the following steps.

S401: The client sends a play request for one channel of streaming media to the streaming media server. Correspondingly, the streaming media server receives the sent play request for one channel of streaming media.

For example, if a user wants to watch a video open class by using a mobile phone, the user taps an icon of a streaming media client on the mobile phone, starts the streaming media client to display an interface of the streaming media client, and then taps a video open class page in the interface. A CDN server receives, in response to the operation of the user, a play request that is for the video open class and that is sent by the mobile phone by using the streaming media client.

S402: The streaming media server selects N streaming media buffer nodes from M streaming media buffer nodes that buffer segments of the streaming media.

M is greater than N. When N is 1, the one selected streaming media buffer node buffers all segments of the streaming media. When N is greater than 1, the N selected streaming media buffer nodes each buffer a part of segments of the streaming media.

S403: The streaming media server sends a streaming media playlist to the client.

The streaming media playlist includes addresses of the N streaming media buffer nodes, and the streaming media playlist indicates the client to obtain the segments of the streaming media based on the addresses of the N streaming media buffer nodes to play the streaming media.

S404: The client parses the streaming media playlist to obtain the addresses of the N streaming media buffer nodes.

For example, the client parses a playlist of the video open class to obtain an address http://a.com:80 of a streaming media buffer node A, an address http://b.com:80 of a streaming media buffer node B, and an address http://c.com:80 of a streaming media buffer node C.

S405: The client requests the segments of the streaming media from the N streaming media buffer nodes.

For example, the client requests a segment 1 of the video open class from the streaming media buffer node A based on the address http://a.com:80 of the streaming media buffer node A, requests a segment 2 of the video open class from the streaming media buffer node B based on the address http://b.com:80 of the streaming media buffer node B, and requests a segment 3 of the video open class from the streaming media buffer node C based on the address http://c.com:80 of the streaming media buffer node C.

S406: The streaming media buffer node sends the segments of the streaming media to the client. Correspondingly, the client receives the segment of the streaming media.

For example, the streaming media buffer node A sends the segment 1 of the video open class to the client, the streaming media buffer node B sends the segment 2 of the video open class to the client, and the streaming media buffer node C sends the segment 3 of the video open class to the client. The client receives the segment 1 of the video open class, the segment 2 of the video open class, and the segment 3 of the video open class.

S407: The client plays the streaming media based on the segments of the streaming media.

For example, the client plays the video open class based on the segment 1 of the video open class, the segment 2 of the video open class, and the segment 3 of the video open class.

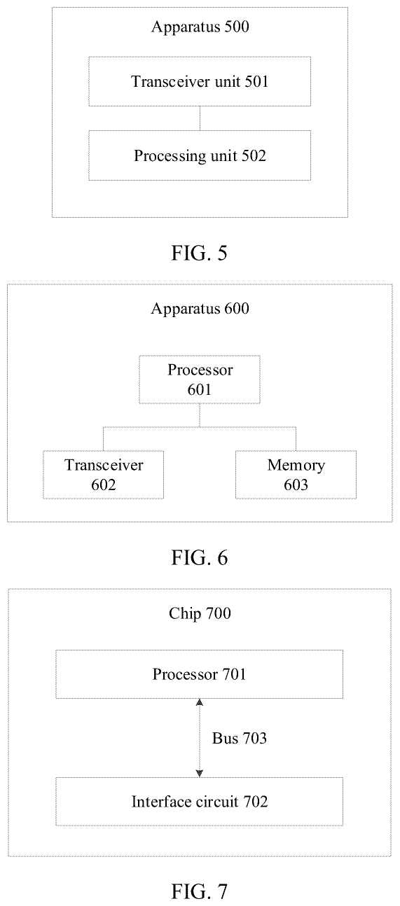

The following describes an electronic device configured to perform the foregoing streaming media scheduling method with reference to FIG. 5 and FIG. 6.

It may be understood that, to implement the foregoing functions, the electronic device includes corresponding hardware and/or software modules for performing the functions. With reference to algorithm steps of examples described in embodiments disclosed in this specification, the present disclosure can be implemented in a form of hardware or combination of hardware and computer software. Whether a function is performed by hardware or hardware driven by computer software depends on particular applications and design constraints of the technical solutions. A person skilled in the art may use different methods to implement the described functions for each specific application with reference to embodiments, but it should not be considered that the implementation goes beyond the scope of the present disclosure.

In embodiments of the present disclosure, the electronic device may be divided into functional modules based on the example in the foregoing method. For example, each functional module corresponding to each function may be obtained through division, or two or more functions may be integrated into one processing module. The integrated module may be implemented in a form of hardware. It should be noted that module division in this embodiment is an example and is merely logical function division. During actual implementation, there may be another division manner.

When each functional module is obtained through division based on each corresponding function, FIG. 5 is a possible schematic diagram of composition of the electronic device in the foregoing embodiment. As shown in FIG. 5, an apparatus 500 may include a transceiver unit 501 and a processing unit 502. The processing unit 502 may implement the method performed by the electronic device in the foregoing method embodiment, and/or another process of the technology described in this specification.

It should be noted that all related content of the steps in the foregoing method embodiments may be cited in function descriptions of corresponding functional modules. Details are not described herein again.

When an integrated unit is used, the apparatus 500 may include a processing unit, a storage unit, and a communication unit. The processing unit may be configured to control and manage an action of the apparatus 500, for example, may be configured to support the apparatus 500 in performing the steps performed by the foregoing units. The storage unit may be configured to support the apparatus 500 in storing program code and/or data, and the like. The communication unit may be configured to support communication between the apparatus 500 and another device.

The processing unit may be a processor or a controller. The processing unit may implement or execute various examples of logical blocks, modules, and circuits described with reference to content disclosed in the present disclosure. Alternatively, the processor may be a combination for implementing a computing function, for example, a combination of one or more microprocessors, a combination of a digital signal processor (DSP) and a microprocessor, or the like. The storage unit may be a memory. The communication unit may be specifically a device, for example, a radio frequency circuit, a Bluetooth chip, a Wi-Fi chip, or the like that interacts with another electronic device.

In a possible implementation, the electronic device in this embodiment of the present disclosure may be an apparatus 600 that has a structure shown in FIG. 6. The apparatus 600 includes a processor 601 and a transceiver 602. A related function implemented by the transceiver unit 501 and the processing unit 502 in FIG. 5 may be implemented by the processor 601.

Optionally, the apparatus 600 may further include a memory 603. The processor 601 and the memory 603 communicate with each other through an internal connection path. A related function implemented by the storage unit in FIG. 5 may be implemented by the memory 603.

This embodiment of the present disclosure further provides a computer storage medium. The computer storage medium stores computer instructions. When the computer instructions are run on an electronic device, the electronic device is enabled to perform the related method steps, to implement the streaming media scheduling method in the foregoing embodiments.

An embodiment of the present disclosure further provides a computer program product. When the computer program product is run on a computer, the computer is enabled to perform the foregoing related steps, to implement the streaming media scheduling method in the foregoing embodiments.

An embodiment of the present disclosure further provides an electronic device. The apparatus may be specifically a chip, an integrated circuit, a component, or a module. Specifically, the apparatus may include a memory configured to store instructions and a processor that are connected to each other, or the apparatus includes at least one processor, configured to obtain instructions from an external memory. When the apparatus is run, the processor may execute the instructions, to enable the chip to perform the streaming media scheduling method in the foregoing method embodiments.

FIG. 7 is a schematic diagram of a structure of a chip 700. A chip 700 includes one or more processors 701 and an interface circuit 702. Optionally, the chip 700 may further include a bus 703.

The processor 701 may be an integrated circuit chip and has a signal processing capability. In an implementation process, steps in the foregoing streaming media scheduling method may be completed by using a hardware integrated logic circuit in the processor 701, or by using instructions in a form of software.

Optionally, the processor 701 may be a general-purpose processor, DSP, an application-specific integrated circuit (ASIC), a field-programmable gate array (FPGA) or another programmable logic component, a discrete gate or transistor logic component, or a discrete hardware component. The processor 701 may implement or perform the methods and steps that are disclosed in embodiments of the present disclosure. The general-purpose processor may be a microprocessor, or the processor may be any processor, or the like.

The interface circuit 702 may send or receive data, instructions, or information. The processor 701 may process the data, the instructions, or other information received through the interface circuit 702, and send, through the interface circuit 702, information obtained through processing.

Optionally, the chip further includes a memory. The memory may include a read-only memory and a random access memory, and provide operation instructions and data for the processor. A part of the memory may further include a non-volatile random access memory (NVRAM).

Optionally, the memory stores an executable software module or a data structure, and the processor may perform a corresponding operation by invoking operation instructions (the operation instructions may be stored in an operating system) stored in the memory.

Optionally, the chip may be used in the electronic device or DOP in embodiments of the present disclosure. Optionally, the interface circuit 702 may be configured to output an execution result of the processor 701. For the streaming media scheduling method provided in one or more embodiments of the present disclosure, refer to the foregoing embodiments, and details are not described herein again.

It should be noted that functions corresponding to each of the processor 701 and the interface circuit 702 may be implemented by using a hardware design, may be implemented by using a software design, or may be implemented by using a combination of software and hardware. This is not limited herein.

The apparatus, the computer storage medium, the computer program product, or the chip provided in embodiments are all configured to perform the corresponding method provided above. Therefore, for beneficial effects that can be achieved by the apparatus, the computer storage medium, the computer program product, and the chip, refer to beneficial effects in the corresponding method provided above. Details are not described herein again.

It should be understood that sequence numbers of the foregoing processes do not mean execution sequences in embodiments of the present disclosure. The execution sequences of the processes should be determined based on functions and internal logic of the processes, and should not constitute any limitation on implementation processes of embodiments of the present disclosure.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each specific application, but it should not be considered that the implementation goes beyond the scope of the present disclosure.

A person skilled in the art may clearly understand that, for the purpose of convenient and brief descriptions, for a detailed working process of the foregoing system, apparatus, and unit, refer to a corresponding process in the foregoing method embodiments, and details are not described herein again.

In the several embodiments provided in the present disclosure, it should be understood that the disclosed system, apparatus, and method may be implemented in another manner. For example, the described apparatus embodiment is merely an example. For example, division of units is merely logical function division and there may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, to be specific, may be located in one position, or may be distributed on a plurality of network units. Some or all of the units may be selected based on actual requirements to achieve the objectives of the solutions of embodiments.

In addition, functional units in embodiments of the present disclosure may be integrated into one processing unit, or each of the units may exist alone physically, or two or more units may be integrated into one unit.

When the functions are implemented in a form of software functional unit and sold or used as an independent product, the functions may be stored in a computer-readable storage medium. Based on such an understanding, the technical solutions of the present disclosure essentially, or the part contributing to the technology, or all or a part of the technical solutions may be implemented in the form of a software product. The computer software product is stored in a storage medium and includes several instructions for instructing a computer device (which may be a personal computer, a server, or a network device) to perform all or a part of the steps of the methods described in embodiments of the present disclosure. The storage medium includes any medium that can store program code, such as a USB flash drive, a removable hard disk, a read-only memory (ROM), a random access memory (RAM), a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A streaming media scheduling method comprising:
receiving a play request from a first client, wherein the play request is for one channel of streaming media;
selecting N streaming media buffer nodes from M streaming media buffer nodes, wherein M and N are positive integers, wherein M is greater than N, wherein when N is greater than 1, each of the N streaming media buffer nodes is configured to buffer at least some of first segments, and wherein the M streaming media buffer nodes are configured to buffer the first segments of the streaming media; and
sending a streaming media playlist to the first client,
wherein the streaming media playlist comprises first addresses of the N streaming media buffer nodes and indicates to the first client to obtain the first segments based on the first addresses to play the streaming media.

2. The method according to claim 1, wherein the method further comprises determining K second clients that are configured to buffer second segments of the streaming media, wherein the streaming media playlist further comprises second addresses of the K second clients and further indicates to the first client to further obtain the second addresses to play the streaming media, and wherein K is a positive integer.

3. The method according to claim 1, wherein the streaming media playlist indicates to the first client to obtain the first segments based on the first addresses to play the streaming media.

4. The method according to claim 1, wherein selecting the N streaming media buffer nodes comprises selecting, based on status information of the M streaming media buffer nodes, the N streaming media buffer nodes from the M streaming media buffer nodes, wherein the status information comprises at least one of load information, memory utilization, an available memory, storage space utilization, an available storage space, a network type, or streaming media segment storage information.

5. The method according to claim 4, wherein the network type indicates one of a plurality of network types including a dedicated network type of a first streaming media buffer node, and wherein the streaming media segment storage information indicates a segment of the streaming media that is stored in the first streaming media buffer node.

6. The method according to claim 1, wherein selecting the N streaming media buffer nodes comprises selecting the N streaming media buffer nodes with lowest load rates from the M streaming media buffer nodes, wherein when N is 1, a first load rate of a selected streaming media buffer node is a lowest load rate in the M streaming media buffer nodes, or when N is greater than 1, a load rate of each streaming media buffer node in the selected N streaming media buffer nodes is a lowest load rate in the streaming media buffer nodes that are each configured to buffer some of the first segments.

7. The method according to claim 1, wherein selecting the N streaming media buffer nodes comprises selecting, based on status information of the M streaming media buffer nodes and attribute information of the M streaming media buffer nodes, the N streaming media buffer nodes from the M streaming media buffer nodes, wherein the status information comprises at least one of load information, memory utilization, an available memory, storage space utilization, an available storage space, a network type, or streaming media segment storage information, and wherein the attribute information comprises at least one of an inter-node address, attribute parameter information, or streaming media segment content information.

8. A streaming media scheduling method comprising:
receiving target information from a streaming media server, wherein the target information comprises first attribute information of M streaming media buffer nodes and second attribute information of K second clients, and wherein M and K are positive integers; and
downloading a plurality of first segments of streaming media based on the first attribute information and the second attribute information.

9. The method according to claim 8, wherein the target information further comprises a streaming media playlist, and wherein downloading the first segments based on the first attribute information comprises downloading the first segments based on the streaming media playlist and the first attribute information, wherein the streaming media playlist comprises first addresses of N streaming media buffer nodes, wherein N is a positive integer that is smaller than M, and wherein the streaming media playlist indicates to a first client to obtain the first segments based on the first addresses to play the streaming media.

10. The method according to claim 9, wherein downloading the first segments based on the streaming media playlist and the first attribute information comprises:
obtaining latencies between the first client and the N streaming media buffer nodes based on the streaming media playlist; and
downloading, when a latency between the first client and any streaming media buffer node in the N streaming media buffer nodes is greater than a latency threshold, the plurality of segments based on the first attribute information.

11. The method according to claim 8, wherein the first attribute information comprises at least one of an inter-node address, attribute parameter information, or streaming media segment content information.

12. The method according to claim 9, wherein the method further comprises downloading in parallel when N is equal to a quantity of segments of the streaming media, different segments using different streaming media buffer nodes.

13. An apparatus comprising:
a memory configured to store instructions; and
one or more processors coupled to the memory and configured to execute the instructions to cause the apparatus to:
receive a play request from a first client, wherein the play request is for one channel of streaming media;
select N streaming media buffer nodes from M streaming media buffer nodes,
wherein M and N are positive integers, wherein M is greater than N, wherein when N is greater than 1, each of the N streaming media buffer nodes is configured to buffer at least some of first segments, and wherein the M streaming media buffer nodes are configured to buffer the first segments of the streaming media; and
send a streaming media playlist to the first client,
wherein the streaming media playlist comprises first addresses of the N streaming media buffer nodes and indicates the first client to obtain the first segments based on the first addresses to play the streaming media.

14. The apparatus according to claim 13, wherein when executed by the one or more processors, the instructions further cause the apparatus to determine K second clients that are configured to buffer second segments of the streaming media, wherein the streaming media playlist further comprises second addresses of the K second clients and further indicates to the first client to further obtain the second addresses to play the streaming media.

15. The apparatus according to claim 13, wherein the N streaming media buffer nodes are configured to buffer all the first segments, and wherein the streaming media playlist indicates the first client to obtain the first segments based on the first addresses to play the streaming media.

16. The apparatus according to claim 14, wherein the streaming media buffer nodes comprise one or more buffer nodes that are configured to store the first segments in a distributed storage manner.

17. The apparatus according to claim 13, wherein when executed by the one or more processors, the instructions further cause the apparatus to select, based on status information of the M streaming media buffer nodes, the N streaming media buffer nodes from the M streaming media buffer nodes, wherein the status information comprises at least one of load information, memory utilization, an available memory, storage space utilization, an available storage space, a network type, or streaming media segment storage information.

18. The apparatus according to claim 13, wherein when executed by the one or more processors, the instructions further cause the apparatus to select the N streaming media buffer nodes with lowest load rates from the M streaming media buffer nodes, wherein when N is 1, a first load rate of a selected streaming media buffer node is a lowest load rate in the M streaming media buffer nodes, or when N is greater than 1, a load rate of each streaming media buffer node in the N streaming media buffer nodes is a lowest load rate in the streaming media buffer nodes that are each configured to buffer some of the first segments.

19. The apparatus according to claim 13, wherein when executed by the one or more processors, the instructions further cause the apparatus to select, based on status information of the M streaming media buffer nodes and attribute information of the M streaming media buffer nodes, the N streaming media buffer nodes from the M streaming media buffer nodes, wherein the status information comprises at least one of load information, memory utilization, an available memory, storage space utilization, an available storage space, a network type, or streaming media segment storage information, and wherein the attribute information comprises at least one of an inter-node address, attribute parameter information, or streaming media segment content information.

20. The apparatus according to claim 13, wherein when executed by the one or more processors, the instructions further cause the apparatus to:
receive, from the first client or a streaming media buffer node, a node registration request to complete registration;
registering one of the M streaming media buffer nodes based on the node registration request; and
further selecting the N streaming media buffer nodes from L streaming media buffer nodes that are registered in response to respective node registration requests.
